(19) United States
(12) Patent Application Publication
(10) Pub. No.: US 2008/0114882 A1
(43) Pub. Date: May 15, 2008

(54) Multiplexing Multiple Client Connections in a Single Socket

(76) Inventor: David Alan Christenson, Fergus Falls, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/558,954

(22) Filed: Nov. 13, 2006

(51) Int. Cl. G06F 15/173

(52) U.S. Cl. 709/228

(57) ABSTRACT

An apparatus, program product and method allow for multiple connections to communicate with a server through a single socket without the need for a proxy. A plurality of client connections is associated with a socket. A multiplexer is utilized to multiplex in the socket a plurality of requests received from at least a subset of the plurality of client connections, and to demultiplex in the socket a plurality of responses to such requests and route the plurality of responses to the appropriate client connections.

### FIELD OF THE INVENTION

The present invention generally relates to computers and data communication and, more particularly, to communicating data between a server and multiple clients.

### BACKGROUND OF THE INVENTION

Client-Server applications are commonplace due to the wide availability of networked computers. The client-server concept is a type of distributed network architecture, which enables a client, often a single user computer, or a program running on the same, to make requests to a server, which is often a multi-user computer or a program running on the same. In an environment with multiple clients, each client can send requests to a single server, and the server will process the requests and typically generate responses back to the individual clients. Servers can vary in type being a file server, a web server, an application server, a terminal server, a mail server, etc. While each of these servers have a different purpose, they all have the same basic architecture.

Many computer communications use this client-server model, especially in Internet-based applications where web servers serve web pages and files to web browsers running on client computers. The terms client and server may also relate to two computer processes that are in communication with each other, where one client process typically makes a request for information, for example, a particular web page from a website, and the server process returns a response with the desired information. Often, a prerequisite step required before a client process can make request to a server process is the establishment of a connection between the client and server processes. Then, once the client process connects to the server process, both the client and server computers can use this connection to communicate data until the connection is closed.

A common way that computers communicate over a network and even over the Internet is to use TCP (Transmission Control Protocol), which was developed to get data from one networked device or computer to another. TCP/IP is a set of protocols including TCP that was developed for the Internet in the 1970s for data transmission. HTTP is a newer protocol that is used for browsing web site pages on the Internet. HTTP is a method used to transfer or convey information on the World Wide Web. A web browser running on a client utilizes protocols, such as TCP, to establish connections with the web server and will use the HTTP protocol over the connection to communicate and transfer data between the client and server computers.

The endpoints of the processes that connect to communicate between the client and server are known as sockets. Each of the client and server processes will typically establish its own socket for communication over the process connection.

The establishment of sockets and connections however, can be problematic, particularly for servers that are handling requests from large numbers of clients. Creating a new TCP socket for an inbound TCP connection (i.e., passive open) is often extremely CPU intensive and consumes considerable server memory resources. When a user requests a web page, a single client browser may initiate numerous TCP connections and thus may expend significant resources in connection with opening and closing these nonpersistent connections. HTTP/1.1 persistent connections may reduce the connection overhead by allowing multiple HTTP requests per client connection; however, allowing idle sockets to remain open for long periods of time can drain server resources. So either alternative, short nonpersistent connections and long persistent connections, can significantly affect web server performance and capacity.

A common solution for this problem is to place a TCP multiplexing device in front of the web server to consolidate incoming HTTP requests to reduce the number of times server connections have to be made. A TCP multiplexing device often significantly reduces the number of open server sockets by multiplexing numerous client connections into fewer persistent server connections. The connection multiplexing ratio can be as high as 350 client connections to 1 server connection, significantly off-loading client connection processing from the web server. Since the persistent server connections are shared by many client connections they can remain active indefinitely without draining server resources.

A conventional TCP multiplexing device uses a layer-7 reverse proxy to consolidate multiple client HTTP requests into a single connection to the web server. The proxy device receives client requests, consolidates them and applies logic to the opening and closing of server connections. HTTP/1.1 pipelining may be exploited because HTTP/1.1 allows multiple HTTP requests to be sent on a single connection without waiting for the corresponding responses. The requester then waits for the responses to arrive in the order in which they were requested. The connection between the TCP multiplexing device and the server can remain open without significantly draining server resources because the connection may be continually reused with other client requests.

The benefits of TCP multiplexing are quite obvious; however, the additional network complexity and cost may be prohibitive for less sophisticated and/or budget conscious customers. Even if the device itself is economically priced, adding technical staff to manage the increased network complexity is not inexpensive.

Software has been utilized to integrate TCP multiplexing into an operating system kernel and thus provide an alternative to an outboard TCP multiplexing device. An internal loopback interface may be used by the client software on a computer to communicate with server software on the same computer. However, multiplexing through a proxy to an internal loopback server connection allocates two TCP endpoint objects for each server connection, one for the proxy side and one for the server side. As a result, proxying through a loopback connection adds additional path length and consumes valuable server resources.

Each of the above mentioned solutions have one common problem, that problem being that each of the solutions requires additional hardware or additional server resources, adding both complexity and/or cost to the solution. Accordingly, there is a need in the art for an improved way of multiplexing client connections without adding cost or draining server resources.

### SUMMARY OF THE INVENTION

The invention addresses these and other problems associated with the prior art by providing an apparatus, program product, and method that utilize socket multiplexing to multiplex and demultiplex data from and to multiple client connections established in a server. By multiplexing multiple connections through a socket, embodiments consistent with the invention are often able to increase a server's workload capacity without adding the expense, effort and complexity that is present otherwise in conventional designs that use external hardware or loopback connections. In fact, in many embodiments consistent with the invention, there are no additional hardware requirements and the solution may be fully integrated into server's kernel, resulting in a lower overall cost and reduced maintenance of overhead.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

These and further features of the present invention will be apparent with reference to the following description and drawings wherein:

FIG. 1 is a block diagram of an exemplary hardware and software environment for a generic computer, within which is implemented socket multiplexing and demultiplexing consistent with the invention.

FIG. 2 is a diagram of a server of a web application communicating with multiple clients through a multiplexed socket.

FIG. 3 is a block diagram of an internal structure used to multiplex an inbound HTTP request from a TCP connection as illustrated in FIG. 2 to a persistent socket.

FIG. 4 is a flow diagram showing the path of HTTP requests from the clients shown in FIG. 2 multiplexed in a socket.

FIG. 5 is a flow chart detailing the processing of an inbound HTTP request with socket multiplexing.

FIG. 6 is a block diagram of an internal structure used to demultiplex an outbound HTTP response from the socket to the correct TCP Connection as illustrated in FIG. 2.

FIG. 7 is a flow diagram showing the path of HTTP responses demultiplexed from a single socket back to the appropriate TCP connection and sent back to the clients shown in FIG. 2.

FIG. 8 is a flow chart detailing the processing of an outbound HTTP response with socket multiplexing.

FIG. 9 is a flow chart showing an initialization of socket multiplexing.

FIG. 10 is a flow chart detailing the process of sending a non-persistent HTTP request through a socket with multiplexing after the initialization in FIG. 9.

FIG. 11 is a flow chart detailing the process of returning an HTTP response to the non-persistent request received in FIG. 10 to the client.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments may have been enlarged or distorted relative to others to facilitate visualization and clear understanding. In particular, thin features may be thickened, for example, for clarity or illustration.

### DETAILED DESCRIPTION

The embodiments described hereinafter utilize a method for multiplexing multiple client requests for multiple data connections in a single socket to a server. The server processes the requests without being encumbered by the additional overhead associated with each connection having its own socket. A server can be any device that connects with multiple devices to communicate data. Situations where this might be applicable are web server applications where servers are receiving a continued stream of client requests for data. Servers may also execute client applications that require data or information from another server. Here the server executing the client application becomes a client to a new server. A server can be both a server and client simultaneously as well, when the client application executing on the server requires data from a server application that is also executing on the same or different server.

### Hardware and Software Environment

Turning to the drawings, wherein like numbers denote like parts throughout the several views, FIG. 1 illustrates an exemplary hardware and software environment for an apparatus 8 suitable for implementing socket multiplexing consistent with the invention. For the purposes of the invention, apparatus 8 may represent any programmable device capable of communicating with other computers or programmable devices via packet-based communication, for example multi-user or single-user computers, desktop computers, portable computers and devices, handheld devices, network devices, mobile phones, etc. Apparatus 8 will hereinafter be referred to as a “computer” although it should be appreciated that the term “apparatus” may also include other suitable programmable electronic devices.

Computer 8 typically includes at least one processor 26 coupled to a memory 16. Processor 26 may represent one or more processors (e.g. microprocessors), and memory 16 may represent the random access memory (RAM) devices comprising the main storage of computer 8, as well as any supplemental levels of memory, e.g., cache memories, non-volatile or backup memories (e.g. programmable or flash memories), read-only memories, etc. In addition, memory 16 may be considered to include memory storage physically located elsewhere in computer 8, e.g., any cache memory in a processor 26, as well as any storage capacity used as a virtual memory, e.g., as stored on a mass storage device (not shown) or another computer coupled to computer 8 via a network 24.

Computer 8 also typically receives a number of inputs and outputs for communicating information externally. For interface with a user or operator, computer 8 typically includes one or more user input devices 10 (e.g., a keyboard, a mouse, a trackball, a joystick, a touchpad, a keypad, a stylus, and/or a microphone, among others). Computer 8 may also include a display 12 (e.g., a CRT monitor, an LCD display panel, and/or a speaker, among others). The interface to computer 8 may also be through an external terminal connected directly or remotely to computer 8, or through another computer communicating with computer 8 via a network 24, modem, or other type of communications device.

Computer 8 operates under the control of a kernel 22 and operating system 20 (which may be separate components, or alternatively may be considered to be the same component), and executes or otherwise relies upon various computer software applications, components, programs, objects, modules, data structures, etc. (e.g. web application 18). Moreover, various applications, components, programs, objects, modules, etc. may also execute on one or more processors in another computer coupled to computer 8 via a network 24, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

### Multiplexing in a Socket

Socket multiplexing as described herein is capable of providing a performance competitive integrated alternative to an outboard TCP multiplexing device. Socket multiplexing consolidates multiple client connections into a single persistent socket without the need for proxying through a loopback connection. In addition, in some embodiments, socket multiplexing may support concurrent pipelining of requests from multiple clients into a single persistent socket, by exploiting HTTP/1.1, for example. With pipelining, if a client sends multiple back-to-back requests on a single client connection, subsequent requests may be queued until the response is served for the current request.

In some embodiments, load balancing algorithms may be used with socket multiplexing to evenly distribute client connections across persistent sockets and enforce any socket sharing limits. Server based socket multiplexing may also be combined with an outboard TCP multiplexing device to even further optimize the server performance and capacity.

The discussion hereinafter will focus on data flow between a client data connection and a server. On the server side, as shown in the exemplary hardware and software environment of FIG. 1, a server application such as the HTTP server 314 of web application 18 is running in the memory 16 of the server computer 8, waiting for requests from client computers. A client computer makes an HTTP request, which may come through the network 24 and the client computer may make a connection, such as a TCP connection 106, with the server computer 8. The kernel 22 creates a new socket 100 with multiplexing 102, 202 or utilizes an existing socket 100 with multiplexing 102, 202 to communicate with the TCP connection 106. Communications commence between the client and server computer 8. While HTTP is being utilized for this one particular embodiment of the invention, socket multiplexing may be used with other communication protocols as well. Likewise, while TCP connections are being utilized to illustrate the client data connections in this particular embodiment, other types of data connections may be utilized with socket multiplexing as will be apparent to those skilled in the art given the benefit of this disclosure.

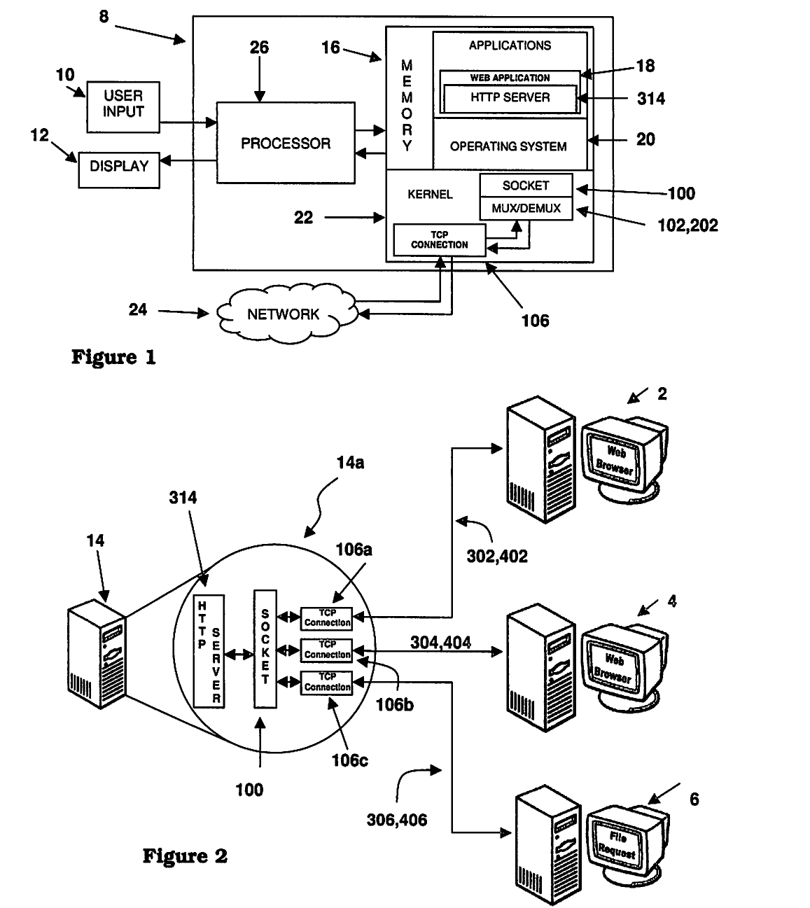

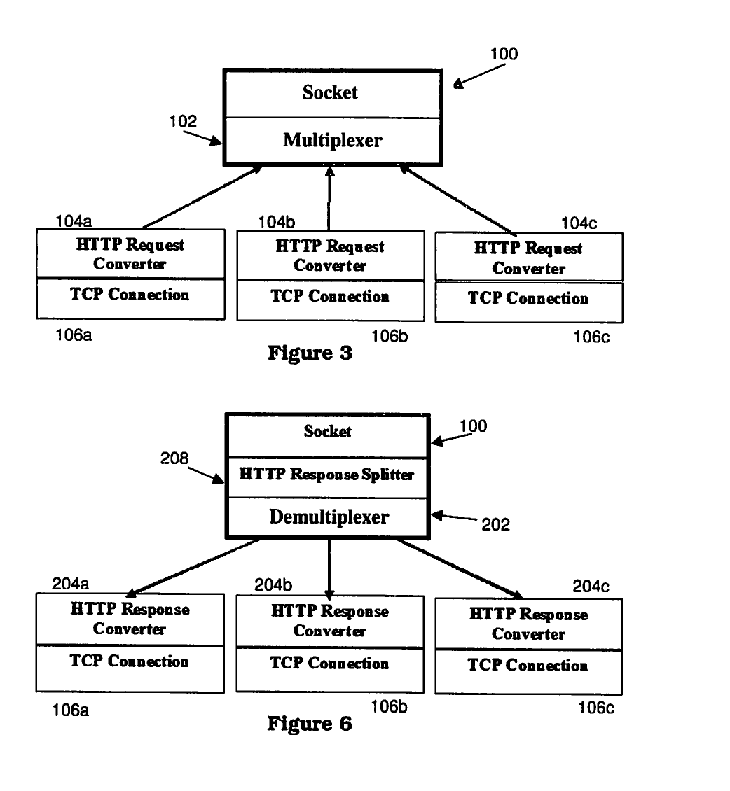

Referring now to FIG. 2, an exemplary distributed computing environment incorporating socket multiplexing is illustrated. In this environment, client computers 2, 4, 6 are shown running local applications such as web browsers that require data from a web server computer 14. Two of the client computers 2, 4 require some type of dynamic web page or event to be generated on the server. One of the client computers 6 only requires the retrieval of a file. All three of the client computers establish connections 106a, 106b, 106c using TCP protocol. Because socket multiplexing has been enabled, the web server computer 14 does not create separate sockets for each request from the three client computers 2, 4, 6. Instead, as shown in the expanded detail 14a of server computer 14, the requests are directed toward a common socket 100, which multiplexes the requests and sends them to the HTTP server 314. The requests are processed and responses from the HTTP server 314 are sent back to the socket 100 where they are demultiplexed and sent to the appropriate client computer 2, 4, 6. The socket 100 sends the dynamic web page or event data to client computers 2, 4 and sends the file to client computer 6.

The block diagram in FIG. 3 shows additional detail between the TCP connections 106a, 106b 106c and the socket 100 for inbound requests. An HTTP Request Converter 104a, 104b, 104c may be used, when needed, to convert the HTTP request data. The HTTP Request Converter module 104a, 104b, 104c converts input requests that are in non-persistent HTTP form into HTTP/1.1 persistent requests (e.g., keepalive requests) so the socket 100 remains open after a response is returned. Socket 100 can then be reused by other requests on other client TCP connections; reducing the overhead of opening and closing sockets on the server. The HTTP Request Converter module 104a, 104b, 104c may be optional for embodiments that send only persistent requests or in embodiments using a protocol other than HTTP.

In contrast to conventional TCP/IP communication stacks, where there is a one to one relationship between the socket and TCP connection, multiple client TCP connections 106a, 106b, 106c are attached to and associated with the same persistent socket 100. Note, the TCP Connection may only be associated with a socket during a request/response exchange in some embodiments. That is, a different socket may be selected for subsequent HTTP requests in embodiments that utilize load balancing.

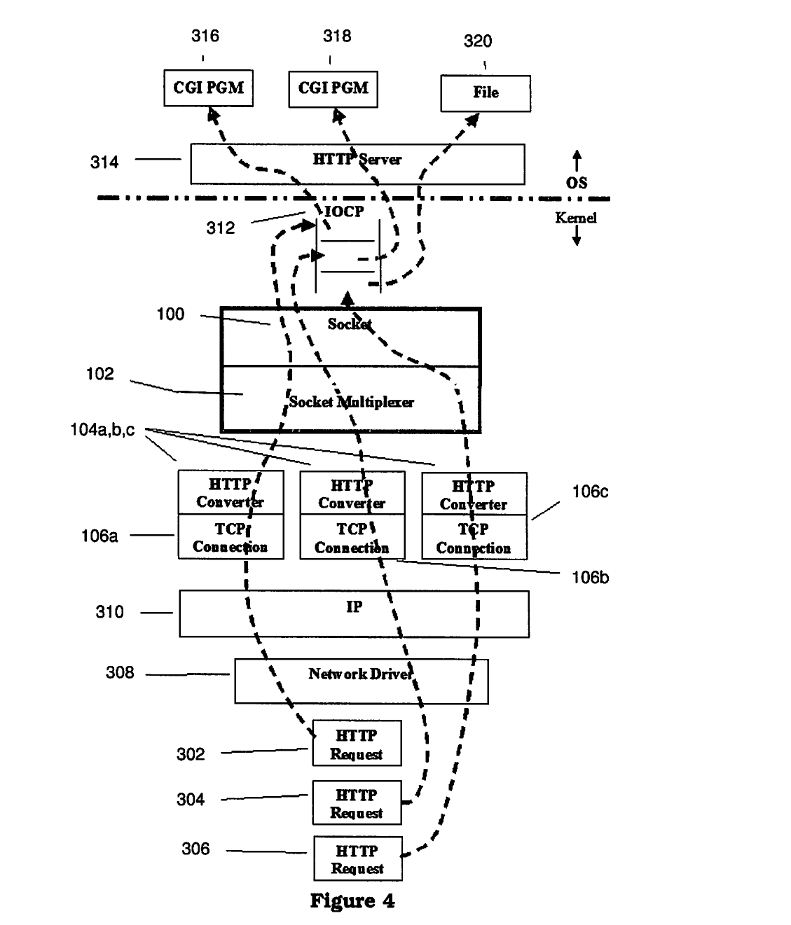

The flow diagram in FIG. 4, providing detail to processing of inbound requests, shows the path of the HTTP requests from the three clients to the HTTP server in FIG. 2 that are diagrammatically indicated by the single headed arrows 302, 304, 306. HTTP inbound data requests 302, 304 and 306 may be received at the kernel level 22 by the network driver 308 from three different client web browsers (shown in FIG. 2 as references 2, 4, 6), and passed to the IP protocol 310. Because the protocol is TCP, each HTTP inbound data request 302, 304 and 306 is passed to client TCP connections 106a, 106b and 106c, respectively. Note, client TCP connections 106a, 106b and 106c may have been previously created using conventional TCP connection establishment protocol. Each client TCP connection 106a, 106b and 106c, in turn, calls an in kernel HTTP request converter 104a, 104b, 104c, converting non-persistent inbound data requests to persistent inbound data requests, if necessary, to accommodate the persistent socket. Each HTTP inbound data request 302, 304 and 306 identifies HTTP server 314 as its origin server and utilizing socket multiplexing, all the requests are multiplexed 102 in a single socket 100. Note, in alternate embodiments, a load balancer may be utilized to evenly distribute client TCP connections between multiple sockets. The HTTP inbound data requests 302, 304 and 306 are in turn enqueued to the I/O Completion port 312 and an HTTP Server thread is dispatched to perform the HTTP Server 314 processing; passing HTTP inbound data requests 302 and 304 to CGI programs 316 and 318 to generate dynamic pages. HTTP inbound data request 306 is served from the static file 320.

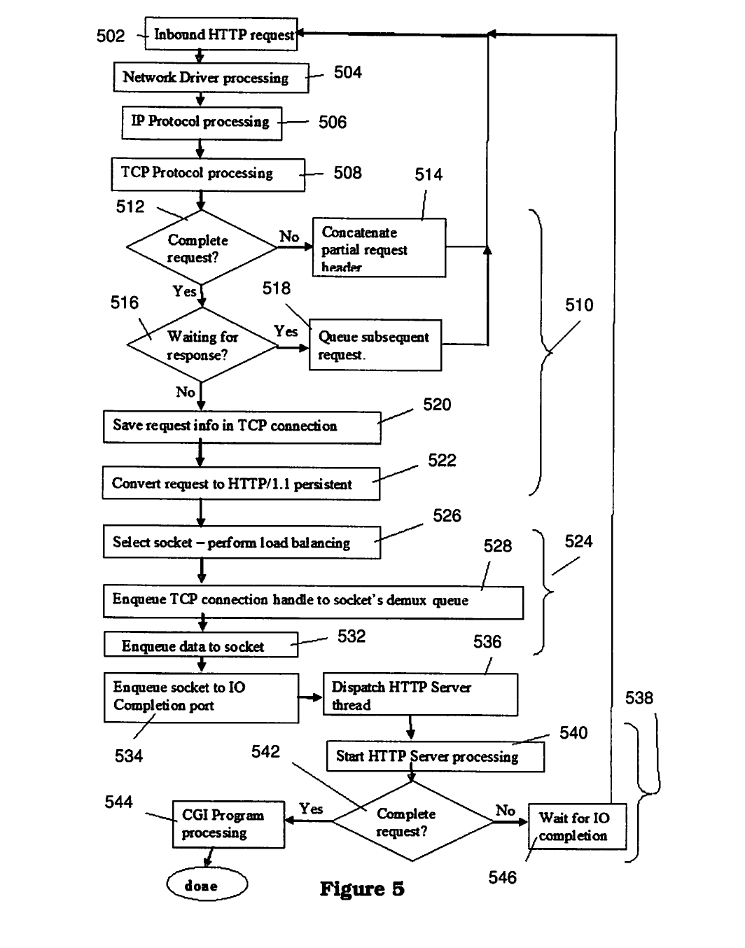

FIG. 5, providing additional detail to processing of inbound requests, is a flowchart detailing the flow path of the inbound HTTP requests in FIG. 4. As shown in block 502, an inbound HTTP request is received and is processed by a network driver in block 504. The request is then passed up through the IP protocol layer in block 506 and TCP protocol layer in block 508. An HTTP request converter in block 510, previously loaded into the kernel, may be called directly by the TCP protocol in block 508. In an embodiment processing non-persistent data requests, the HTTP request converter performs steps in decision block 512 to block 522. If the HTTP request header is incomplete (“No” branch from decision block 512) the request fragment is concatenated in block 514 and processing is delayed until the complete request is received. If the current client connection is already waiting for a response from the server (“Yes” branch from decision block 516), this request must be queued in block 518 until the response for the previous request is served. Otherwise, if the request is complete and the connection is not waiting on a response, request info is saved in the TCP connection in block 520, because it will be needed later to properly handle the corresponding HTTP response. In an embodiment where the request is not an HTTP/1.1 persistent connection, the HTTP request is converted into an HTTP/1.1 persistent request in block 522 to prevent the HTTP Server in block 538 from closing the socket.

The HTTP request is passed to a socket multiplexer incorporated in the socket in block 524, which performs blocks 526 to 532. In an alternate embodiment, a load balancer may be utilized to multiplex over more than one socket. The load balancer in block 526 selects a socket with the fewest number of active HTTP requests. If the socket share limit has been reached on all of the available sockets, a new socket will need to be created. To create a new socket, a passive open is initiated to the server, causing the server to accept a new socket (not shown). The TCP connection handle is enqueued to the socket's demultiplexer queue in block 528 to facilitate the subsequent demultiplexing of the corresponding HTTP response back to the correct TCP connection. Sockets remain open until the HTTP server closes them. The server may close a socket for a number of reasons. One reason to close the socket may be that the socket is the configured for a maximum number of requests per connected socket and that maximum has been reached. Another reason may be that the server may close a socket that has received no requests for specified period of time. Another reason may be that the HTTP server has ended which results in closing all of the sockets. Regardless of the reason, it is typically the HTTP server that determines when to close a socket.

The HTTP request is enqueued to the socket in block 532 followed by an enqueue of the socket to the I/O completion port in block 534. Note, in an alternate embodiment the HTTP Server could communicate without an I/O completion port (a.k.a., asynchronous I/O); however, asynchronous I/O significantly improves server capacity. The asynchronous I/O component dispatches an HTTP Server thread in block 536 to process the HTTP request.

The HTTP Server in block 538 parses the HTTP request, via execution of blocks 540 to 546. First the HTTP server starts processing the request in bock 540. If the request is complete (“Yes” branch from decision block 542), a CGI program (or another program suitable for handling the request) is called to generate the dynamic page (i.e., HTTP outbound data response). Otherwise in block 546, the HTTP Server waits for the remaining portion of the HTTP request to be received.

The block diagram in FIG. 6 shows additional detail between the socket 100 and the TCP connections 106a, 106b, 106c for outbound responses. An HTTP response splitter 208 may be used to split responses when a stream of responses is returned to the socket 100 from the HTTP server. The HTTP response splitter 208 and demultiplexer 202 are integrated into the socket 100. All outbound response data passed to the socket may be directed through the HTTP response splitter 208 and de-multiplexer 202. The HTTP response splitter 208 parses the outbound data stream identifying the start and end of each pipelined response and the demultiplexer 202 directs the response to the correct client TCP connection. An HTTP response converter 204a, 204b, 204c is typically used when the form of the original HTTP request is non-persistent to honor the request from the client. When the HTTP request is non-persistent, the HTTP response converter converts the response back to its non-persistent form (e.g., Connection: close) allowing the client TCP connection to be closed while leaving the socket open for other requests/responses. In alternate embodiments where all requests are persistent requests or embodiments utilizing protocols other than HTTP, the HTTP response converter would be optional.

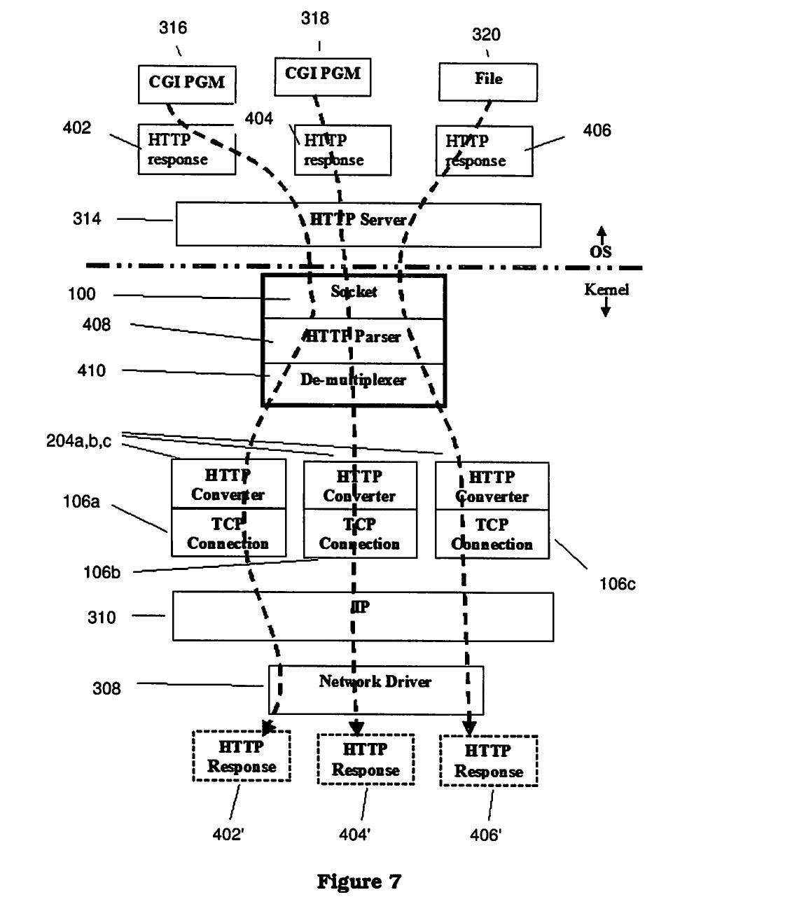

The flow diagram in FIG. 7, providing detail to processing of outbound responses, shows the path of the HTTP responses from the CGI programs and data server through the HTTP server to the clients in FIG. 2 that are diagrammatically indicated by the single headed arrows 402, 404, 406. CGI programs 316 and 318 serve the dynamic pages (outbound data responses 402, 404) requested by HTTP inbound data requests 302 and 304. Static file 320 supplies the HTTP response body (outbound data response 406) for HTTP request 306. HTTP Server 314, in turn, sends each outbound data response 402, 404 and 406 to the same socket descriptor 100. Note, the outbound data responses 402, 404, 406 are returned in the same order as the inbound data requests 302, 304, 306 were received. The outbound data responses 402, 404, 406 are parsed in the socket 100 by the HTTP parser 408 and then demultiplexed 410 to their appropriate client TCP connection 106a, 106b and 106c. Prior to performing the TCP protocol, the HTTP Converter 204a, 204b, 204c may need to modify the response. If the inbound data request 302, 304, 306 was converted from a nonpersistent request to a persistent request to accommodate the persistent socket, then it is desirable to change the outbound data response 402, 404, 406 to match the original request. At this point the HTTP outbound data responses 402, 404 and 406 are passed through the TCP and IP protocol 310, then to the Network Driver 308 and out on the network 24 on their way back to the client web browsers 2, 4, 6 (shown in FIG. 2).

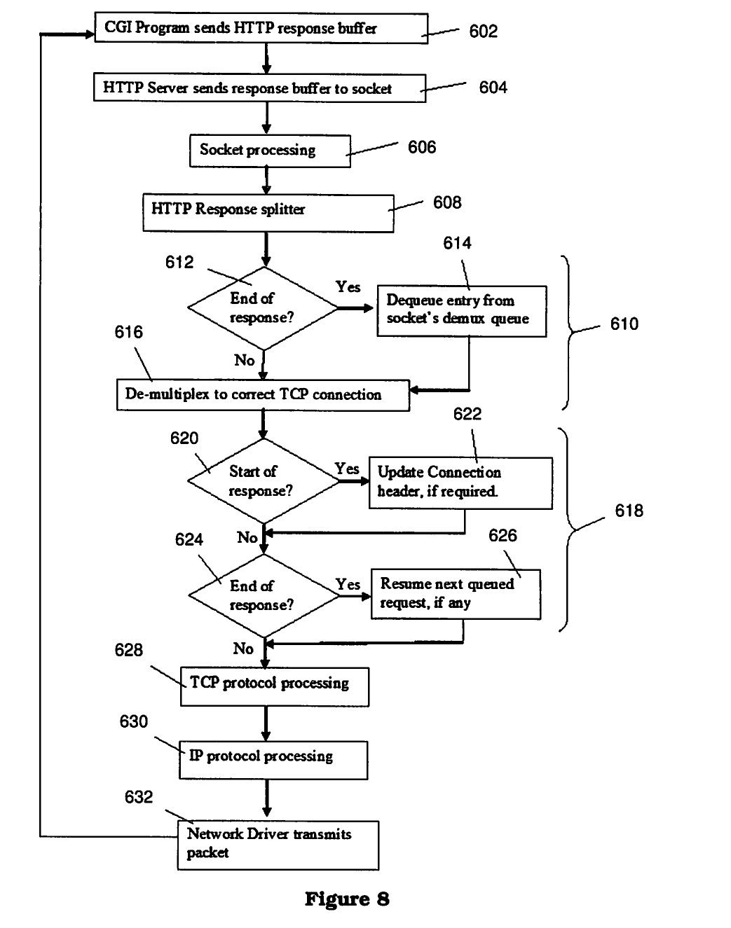

FIG. 8, providing additional detail to processing of outbound responses, is a flowchart detailing the flow path of the outbound HTTP responses in FIG. 7. As shown, the CGI program in block 602 generates a dynamic page and sends it to the HTTP Server in block 604. Note, since a response can be quite large, it may be necessary to send the response in multiple buffers. The HTTP Server sends the response buffer to the socket in block 604 and conventional socket send processing is performed in block 606.

The HTTP response splitter in block 608 determines the start and end of each pipelined response so that each individual response can be demultiplexed to different client TCP connections.

The demultiplexer in block 610 finds the TCP connection identified by the first TCP connection handle in the socket's demultiplexing queue. Blocks 612 to 616 are performed for the demultiplexing. Note, the TCP connection handle was enqueued to the socket's demultiplexing queue in block 528 in FIG. 5. When the end of the response is reached (“Yes” branch from decision block 612), the first entry is dequeued from the socket's demultiplexing queue to prepare for the next HTTP outbound data response. Finally, the HTTP outbound data response is demultiplexed to the appropriate client TCP connection in block 616.

In an embodiment where the inbound data request is not an HTTP/1.1 persistent request, the HTTP Response Converter in block 618 performs the necessary conversions to ensure the HTTP outbound data response is compatible with the client, executing blocks 620 to 623. When the first or only fragment of the HTTP response is processed (“Yes” branch from decision block 620), conversion in block 622 to the HTTP response header may be necessary to ensure compatibility with the client connection. For example, the Connection header value is changed to “Close”, if the original request was nonpersistent. When the last or only response fragment is processed (“Yes” branch from decision block 624) and a request was queued in block 518 in FIG. 5, the next queued request in block 626 is resumed at block 516 in FIG. 5.

The HTTP outbound data response is sent to the TCP protocol processing in block 628 and IP protocol processing in block 630, then the Network Driver transmits the response to the client in block 632.

### Initialization of Multiplexing in a Socket

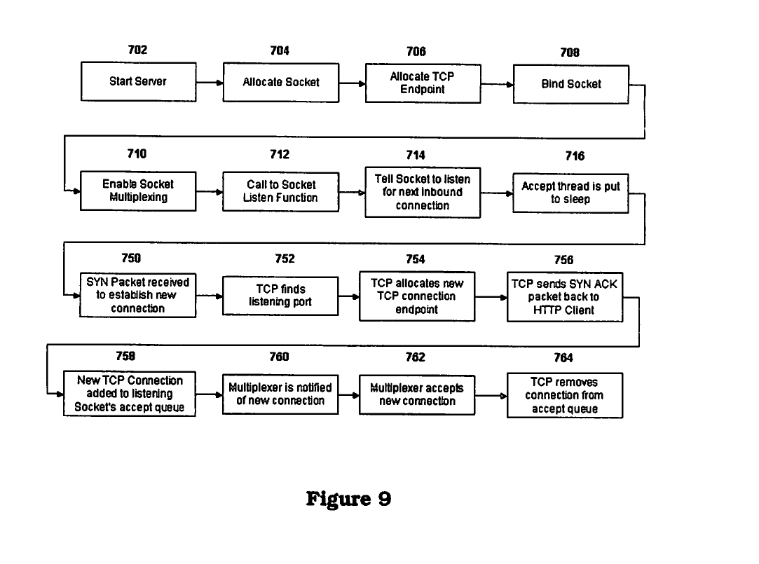

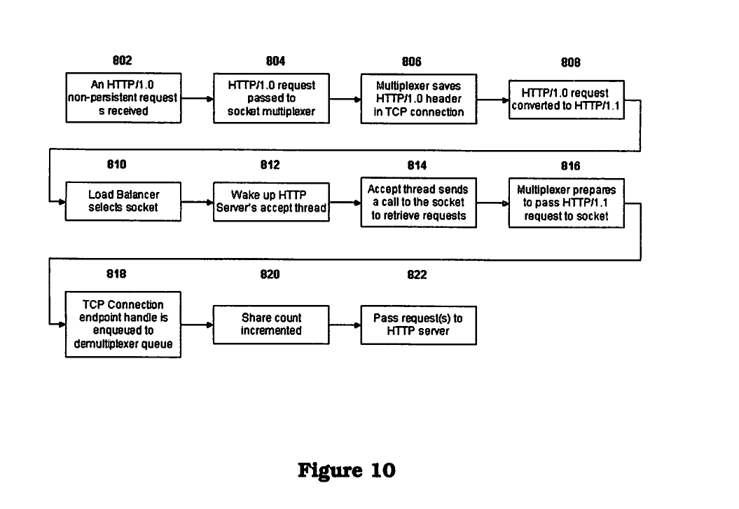

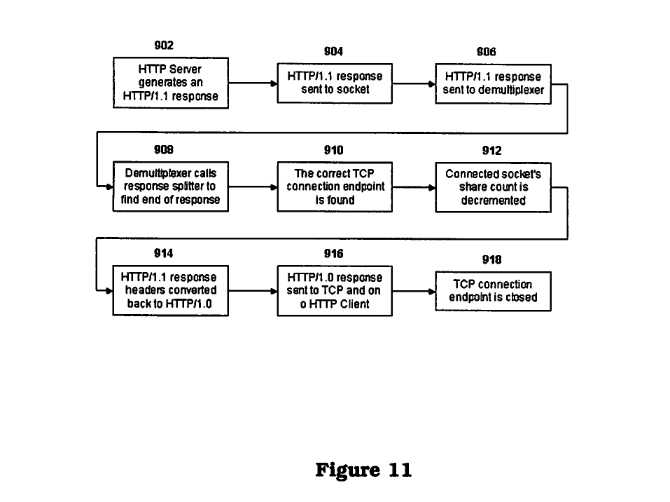

The following example for the present embodiment illustrates the initialization of a socket incorporating socket multiplexing consistent with the invention. A socket with multiplexing is initialized and idled (shown in FIG. 9) until an incoming HTTP client request from a client is sent to the server (shown in FIG. 10). The example is concluded with a response from the server being sent back to the client preserving the open status of the socket (shown in FIG. 11).

Referring now to FIG. 9, the initialization process for socket multiplexing begins when a system administrator starts the HTTP server at block 702. The HTTP server calls a socket function to open a socket, intended for use as a listening socket. A new socket is allocated at block 704. Then a new TCP endpoint object is allocated at block 706 and attached to the new socket. The HTTP server calls the socket bind function to bind the socket at block 708 to port 80 to listen for inbound HTTP connections. The socket binds the TCP endpoint to port 80. The HTTP server then enables socket multiplexing at block 710 for this listening socket. The socket enables socket multiplexing for the associated TCP endpoint. The HTTP server calls the socket listen function at block 712 to start listening for inbound HTTP connections. The socket tells the TCP endpoint to start listening. The HTTP server calls the socket accept function to accept the next inbound HTTP connection at block 714 and the HTTP server's accept thread is put to sleep at block 716. Note, because socket multiplexing is enabled in the socket, the accept function will not be notified for every new connection. The HTTP server will accept the initial connection and subsequent connections can be multiplexed into the same connected socket. In an alternate embodiment, socket multiplexing may create multiple connected sockets by passing a new connected socket to the HTTP server's accept function, and load balance HTTP requests across the multiple connected sockets.

Next, as illustrated by block 750, a SYN (synchronization) packet is received on port 80 to establish a new HTTP connection to the HTTP server. TCP finds the listening socket at block 752 created by the HTTP server. TCP then allocates a new TCP connection endpoint at block 754 to begin the connection establishment. TCP sends a SYN ACK packet (a packet message used in the TCP protocol to acknowledge receipt of a packet) back to the HTTP client at block 756. The HTTP client then returns an ACK packet (TCP acknowledgement) to complete the connection establishment. The new TCP connection is added to the listening socket's accept queue at block 758. Because socket multiplexing is enabled, the multiplexer is notified of the new connection at block 760 waiting in the accept queue. The multiplexer immediately accepts the new connection at block 762. Without multiplexing, the HTTP server typically accepts the connection; however, giving each new connection to the HTTP server is undesirable, because the goal is to multiplex multiple connections into a single connected socket. TCP removes the new connection from the accept queue at block 764. The new connection is returned to the multiplexer to facilitate socket multiplexing. At this point the connection is ready to receive HTTP requests from the client.

### Receiving a Non-Persistent HTTP Request

Referring now to FIG. 10, an HTTP/1.0 non-persistent request is received at block 802. In an alternate embodiment, socket multiplexing may also be utilized to accelerate HTTP/1.1 persistent requests. The non-persistent request was chosen for this particular embodiment to illustrate the protocol conversion step. The HTTP/1.0 inbound data request is passed to the socket multiplexer at block 804. The multiplexer saves the HTTP/1.0 inbound data request headers in the client TCP connection at block 806 for later use to convert the outbound data response back to HTTP/1.0. In alternative embodiments, only a subset of the request headers or a compressed representation of the request header may be saved. Because the request is an HTTP/1.0 request, it is desirable to convert the request to HTTP/1.1 at block 808 before it can be passed to the connected socket (not yet created). The persistent HTTP/1.1 request will allow the HTTP server to keep the connected socket open. In an embodiment utilizing load balancing, the load balancer may then be called to select a connected socket at block 810. Since no sockets have been created yet, a new socket is created. If one or more connected sockets had previously been created and the share count of at least one of the connected sockets was less than the configured share limit, an existing socket with the lowest share count may be selected.

Next, the HTTP server's waiting accept thread must be woken up at block 812, passing the newly created connected socket. Note that unlike a conventional connected socket, multiple TCP endpoints are associated with this connected multiplexed socket. The HTTP server's accept thread dispatches a receive thread to call the socket receive function to receive subsequent HTTP requests at block 814 from multiple TCP connections. Alternative embodiments may use asynchronous (I/O completion ports) or non-blocking I/O to accelerate performance and scalability. Now that a connected socket has been created (selected), the multiplexer prepares to pass the HTTP/1.1 request to the connected socket at block 816. First, the TCP connection endpoint handle is enqueued to the tail of the socket's demultiplexer queue at block 818, to enable the HTTP/1.1 response to be properly demultiplexed back to the correct TCP connection endpoint. Second, the share count is incremented at block 820 to facilitate load balancing, in an embodiment that utilizes load sharing. Next the HTTP/1.1 request is passed to the connected socket at block 822. The receive thread is woken up to pass the HTTP/1.1 request to the HTTP server. The HTTP server processes the static or dynamic request and prepares to send an HTTP/1.1 response. The HTTP server issues another receive operation to wait for another request on the connected socked.

### Responding to a Non-Persistent HTTP Request

Referring now to FIG. 11, the HTTP server generates an HTTP/1.1 response at block 902 and sends it to the connected socket at block 904. Because socket multiplexing is enabled, the HTTP/1.1 outbound data response is sent to the demultiplexer at block 906. The demultiplexer calls the response splitter to find the end of the response at block 908. Though not shown in this example, it is possible that multiple responses are pipelined in the same send buffer and must be routed to separate TCP connection endpoints. In the current example, the HTTP/1.1 outbound data response is the only response in the send buffer, so an end of response indication is returned. Next, the correct client TCP connection endpoint is found at block 910 by dequeuing the first TCP endpoint handle from the connected socket's demultiplexer queue. In an embodiment utilizing load sharing, the connected socket's share count is decremented at block 912 to facilitate load balancing. Note, the next time an HTTP request is received on this TCP connection, load balancing may select a different connected socket. The request headers stored in the TCP connection endpoint are HTTP/1.0, therefore, it is desirable to convert the HTTP/1.1 outbound data response back to an HTTP/1.0 response at block 914 to honor the client's inbound data request. The connection header value is set to “close” as requested by the HTTP client. The HTTP/1.0 response can now be sent to TCP and on to the HTTP client at block 916. The TCP connection endpoint closes at block 918, because HTTP/1.0 non-persistent connections are used by the client. The connected socket remains open, however, and can be used by subsequent HTTP requests until closed by the server.

From the forgoing disclosure and detailed description of certain illustrated embodiments, it will be apparent that various modifications, additions, and other alternative embodiments are possible without departing from the true scope and spirit of the present invention. For example, it will be apparent to those skilled in the art, given the benefit of the present disclosure that a socket multiplexer can work with a variety of different communication protocols and data connections for any type of served data environment. The embodiments that were discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A computer implemented method for communicating data between a server and a plurality of clients, the method comprising:
associating a plurality of client connections with a socket associated with the server;
communicating data associated with the plurality of client connections to the server through the socket, including multiplexing data from the plurality of client connections in the socket; and
communicating data from the server to the plurality of client connections through the socket, including demultiplexing data from the server in the socket and routing the data to appropriate client connections.

2. The method of claim 1 wherein communicating data associated with the plurality of client connections to the server through the socket comprises:
receiving a first inbound data request by a first client connection among the plurality of client connections;
passing the first inbound data request from the first client connection to a socket multiplexer that is associated with the socket;
queuing the first inbound data request by the socket multiplexer; and
routing the first inbound data request to the server.

3. The method of claim 2 wherein the first client connection is a TCP connection.

4. The method of claim 2 wherein the first inbound data request is an HTTP request.

5. The method of claim 2 wherein the socket comprises a persistent socket, the method further comprising converting a non-persistent request into a persistent request.

6. The method of claim 2 wherein the steps of receiving the first inbound data request, passing the first inbound data request to the socket multiplexer, queuing the first inbound data request and routing the first inbound data request to the server are performed by an operating system kernel.

7. The method of claim 1 wherein communicating data from the server to the plurality of client connections comprises:
sending a first outbound data response from the server to the socket;
determining an outbound client connection from the plurality of client connections for the first outbound data response; and
sending the first outbound data response from the socket to the outbound client connection.

8. The method of claim 7 wherein communicating data from the server to the plurality of client connections further includes:
receiving in the socket a plurality of responses from the server containing the first outbound data response; and
parsing the first outbound data response from the plurality of responses.

9. The method of claim 7 wherein the first outbound data response is an HTTP response.

10. The method of claim 7 wherein the socket comprises a persistent socket, the method further comprising converting persistent responses into non-persistent responses.

11. The method of claim 7 wherein the outbound client connection is a TCP connection.

12. An apparatus comprising:
a memory; and
program code resident in the memory, the program code configured to associate a plurality of client connections with a socket associated with a server, to communicate data associated with the plurality of client connections to the server through the socket by multiplexing data from the plurality of client connections in the socket, and to communicate data from the server to the plurality of client connections through the socket by demultiplexing data from the server in the socket and route the data to appropriate client connections.

13. The apparatus of claim 12 wherein the program code is configured to communicate data associated with the plurality of client connections to the server through the socket by receiving a first inbound data request by a first client connection among the plurality of client connections, passing the first inbound data request from the first client connection to a socket multiplexer that is associated with the socket, queuing the first inbound data request by the socket multiplexer, and routing the first inbound data request to the server.

14. The apparatus of claim 13 wherein the first client connection is a TCP connection.

15. The apparatus of claim 13 wherein the first inbound data request is an HTTP request.

16. The apparatus of claim 13 wherein the socket comprises a persistent socket, and wherein the program code is configured to convert a non-persistent request into a persistent request.

17. The apparatus of claim 13 wherein the program code is resident in an operating system kernel.

18. The apparatus of claim 12 wherein the program code is configured to communicate data from the server to the plurality of client connections by sending a first outbound data response to the socket, determining an outbound client connection from the plurality of client connections for the first outbound data response, and sending the first outbound data response from the socket to the outbound client connection.

19. The apparatus of claim 18 wherein the program code is configured to communicate data from the server to the plurality of client connections further by receiving in the socket a plurality of responses from the server containing the first outbound data response, and parsing the first outbound data response from the plurality of responses.

20. The apparatus of claim 18 wherein the first outbound data response is an HTTP response.

21. The apparatus of claim 18 wherein the socket comprises a persistent socket, and wherein the program code is further configured to convert persistent responses into non-persistent responses.

22. The apparatus of claim 18 wherein the outbound client connection is a TCP connection.

23. A program product, comprising:
program code configured to associate a plurality of client connections with a socket associated with a server, communicate data associated with the plurality of client connections to the server through the socket by multiplexing data from the plurality of client connections in the socket, and communicate data from the server to the plurality of client connections through the socket by demultiplexing data from the server in the socket and route the data to appropriate client connections; and
a computer readable medium bearing the program code.

24. The program product of claim 23 wherein the program code is configured to communicate data associated with the plurality of client connections to the server through the socket by receiving a first inbound data request by a first client connection among the plurality of client connections, passing the first inbound data request from the first client connection to a socket multiplexer that is associated with the socket, queuing the first inbound data request by the socket multiplexer, and routing the first inbound data request to the server.

25. The program product of claim 23 wherein the program code is configured to communicate data from the server to the plurality of client connections by sending a first outbound data response to the socket, determining an outbound client connection from the plurality of client connections for the first outbound data response, and sending the first outbound data response from the socket to the outbound client connection.
